(19) United States
(12) Patent Application Publication
(10) Pub. No.: US 2015/0016978 A1
(43) Pub. Date: Jan. 15, 2015

(54) Compressor Housing of Radial Compressor

(71) Applicant: MANN+HUMMEL GMBH, Ludwigsburg (DE)

(72) Inventor: Hedwig Schick, Tamm (DE)

(21) Appl. No.: 14/326,795

(22) Filed: Jul. 9, 2014

(30) Foreign Application Priority Data
Jul. 10, 2013 (DE) 10 2013 011 458.6

(51) Int. Cl. F04D 29/42; F02B 47/08

(52) U.S. Cl. CPC F04D 29/4233; F02B 47/08
USPC 415/204

(57) ABSTRACT

A compressor housing (16) of a radial compressor, in particular of a turbocharger of an internal combustion engine, in particular of a motor vehicle, having at least one housing part (10, 12) is described. A compressor impeller receiving chamber (56) and a spiral channel (46) radially outwardly surrounding said compressor impeller receiving chamber with respect to a rotational axis (18) of a compressor impeller are provided. A separate contour ring (14) is disposed within the at least one housing part (10), which at least radially outwardly surrounds the spiral channel (46). The contour ring (14) forms at least one section (44) of the radially outward inner contour of the spiral channel (46).

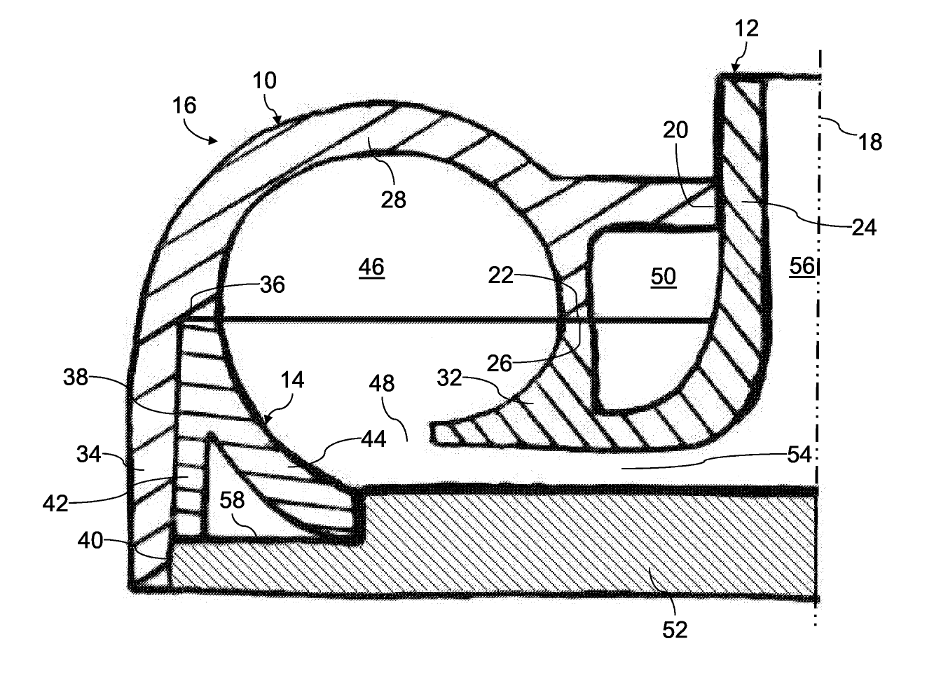

### CROSS-REFERENCE TO RELATED APPLICATION

This application claims the benefit of German patent application No. 10 2013 011 458.6, filed Jul. 10, 2013. The entire contents of the aforesaid German patent application are incorporated herein by reference.

### TECHNICAL FIELD

The invention relates to a compressor housing of a radial compressor, in particular of a turbocharger of an internal combustion engine, in particular of a motor vehicle, having at least one housing part, wherein a compressor impeller receiving chamber and a spiral channel radially outwardly surrounding said compressor impeller receiving chamber with respect to a rotational axis of a compressor impeller are provided.

### BACKGROUND

A compressor housing of a radial compressor, in particular of a turbocharger of an internal combustion engine, in particular of a motor vehicle, having at least two housing parts that consist at least in part of plastic is known from DE 10 2011 017 052 A1. A compressor impeller receiving chamber and a spiral channel radially outwardly surrounding said compressor impeller receiving chamber with respect to a rotational axis of a compressor impeller are provided. A securement structure surrounding the compressor impeller receiving chamber at least partially annularly is disposed in the radial direction between the compressor impeller receiving chamber and the spiral channel. The securement structure comprises a separate burst-protection ring having a tubular wall section surrounding the compressor impeller receiving chamber circumferentially, which wall section is disposed in a fixed manner in its position in the compressor housing.

### DISCLOSURE OF THE INVENTION

The object of the invention is to design a compressor housing of the type mentioned at the outset which is simple to produce and rugged. The compressor housing is supposed to realize the highest possible efficiency with respect to the compression. It should be optimized in terms of material use and weight.

This object is attained according to the invention in that a separate contour ring is disposed within the at least one housing part, which at least radially outwardly surrounds the spiral channel and forms at least one section of the radially outward inner contour of the spiral channel.

As is known, gas compressed with the radial compressor, in particular compressed combustion air of the internal combustion engine, flows in the spiral channel. The spiral channel surrounds the rotational axis of the compressor impeller circumferentially. The to-be-permeated cross-sectional surface thereof increases or decreases circumferentially, depending upon the viewing direction.

According to the invention, a separate contour ring is disposed in the at least one housing part. The contour ring can be inserted advantageously into the at least one housing part. Therefore, the contour ring can also be designated as an insertion ring. The contour ring forms a portion of the inner contour of the spiral channel. The inner contour of the spiral channel designates the wall progression of the wall sections forming the spiral channel. The section of the inner contour that is formed by the contour ring is situated at a radially outward inner side of the spiral channel with respect to the rotational axis. The section of the inner contour is thus situated substantially on the side of the spiral channel that is radially opposite from the compressor impeller receiving chamber.

A complex spiral channel geometry can be realized in a simply way with the contour ring. The complex spiral channel geometry makes it possible to increase the efficiency of the radial compressor.

As a separate part, the contour ring can simply be inserted during assembly into the at least one housing part.

The contour ring can be optimized simply in terms of its function. It can be optimized advantageously with respect to the flow contour of the spiral channel.

By using the contour ring, it is possible for the compressor housing to be realized in a simpler manner, in particular with lower costs for materials and/or assembly and/or more cost-effectively. The contour ring itself can be realized as a simple component.

The contour ring can advantageously be firmly connected to the at least one housing part. The contour ring can be connected to the at least one housing part with a firm bond, in particular by means of welding and/or adhesion, and/or a form-fit, in particular by means of a snap-in connection and/or screwed connection and/or a bayonet-type connection, and/or force-fit, in particular by means of a press-fit. The contour ring can also be connected to the at least one housing part by means of a different kind of connection, in particular a swivel and/or plug-in connection.

The contour ring can be disposed in the at least one housing part so that it is separable. Alternatively, it can be disposed in the at least one housing part so that it is separable non-destructively.

The contour ring can be disposed advantageously within a region that is sealed with respect to the environment in the at least one housing part. This way it is not necessary for the contour ring itself to have a sealing function. Any connection locations between the contour ring and the at least one housing part also do not have to be sealed outwardly. Therefore, the contour ring can be designed in a simple way.

In the case of an advantageous embodiment, the at least one housing part can form a portion of the inner contour of the spiral channel.

The contour ring can advantageously adopt the shape of at least an undercut of the at least one housing part. The contour ring therefore replaces a corresponding section of the inner contour of the spiral channel on the sides of the at least one housing part. With the contour ring instead of the at least one undercut, an extension of the spiral channel that is circumferential with respect to its profile can be formed. Overall, the compressor efficiency of the radial compressor can be increased as compared to a radial compressor without an undercut or contour ring.

Because of the contour ring, it is possible to dispense with an undercut, in particular a radial outer undercut with respect to the rotational axis, on sides of the at least one housing part. The at least one housing part can thus be open in the region of the spiral channel. It can be designed to be better accessible at least during production. The production of the at least one housing part is simplified is this way.

The at least one housing part can advantageously be cast or injected. As is known, a design element, which freely protrudes on the at least one housing part, in particular a cast part, can then be designated as an undercut or counterdraft. The undercut can hamper or prevent the at least one housing part from being removed from its mold, in particular a cast mold. A demolding of the at least one housing part can be simplified by the reduction of the number of undercuts. A casting method for producing the at least one housing part, which comprises at most one undercut in the region of the spiral channel, can be simpler than a casting method for producing a compressor housing with several undercuts. A compressor housing having several undercuts can be produced in particular in accordance with a gravity die casting method.

The at least one housing part can advantageously have no undercut. The demolding of the at least one housing part can be simplified as a result.

The at least one housing part can advantageously comprise a housing-side contour ring receptacle for the contour ring. The housing-side contour ring receptacle can advantageously be radially outward with respect to the rotational axis. Positioned and/or held in a simple manner in the housing-side contour ring receptacle on the contour ring.

The at least one housing part can advantageously be an upper part of the compressor housing. The housing part that is disposed on the side facing axially away from the turbine with respect to the rotational axis can be designated as the upper part.

In the case of another advantageous embodiment, the at least one housing part can be disposed on a bearing seat of the radial compressor.

The bearing seat can serve to mount the compressor impeller. To this end, it can carry a corresponding bearing for the compressor impeller.

The bearing seat can advantageously be a cast part.

The bearing seat can advantageously be mechanically processed on contact surfaces, in particular towards the compressor housing.

The at least one housing part can advantageously comprise a bearing seat receptacle, which can receive corresponding sections of the bearing seat during assembly.

The bearing seat receptacle can advantageously radially outwardly surround the bearing seat with respect to the rotational axis.

The bearing seat receptacle and if applicable the housing-side contour ring receptacle can advantageously merge into each other.

The at least one housing part can be firmly connected to the bearing seat, in particular screwed together. The connection between the at least one housing part and the bearing seat can advantageously be impervious at least for the gas to be compressed. The at least one housing part can also be connected to the bearing seat in another manner.

In the case of another advantageous embodiment, the contour ring can be disposed between the at least one housing part and the bearing seat.

The contour ring can be inserted advantageously into the at least one housing part, as the case may be into the corresponding housing-side receptacle.

The bearing seat can advantageously comprise a contour ring receptacle on the bearing seat side for the contour ring. The contour ring can be positioned and held in a simple manner in the contour ring receptacle on the bearing seat side. It is possible to dispense with a separate fixation of the contour ring on or in the at least one housing part.

The at least one housing part with the inserted contour ring can be connected to the bearing seat. In particular, the at least one housing part can be inserted on the bearing seat. In the process, the contour ring can be advantageously fixed between the at least one housing part and the bearing seat, in particular clamped.

With another advantageous embodiment, the compressor housing can comprise at least two housing parts.

In this way, the two housing parts can each be designed separately in an optimal manner. Each of the housing parts can be simply constructed separately. The housing parts can advantageously each be separately free of undercuts. In this way, the housing parts can each be produced simply, in particular demolded.

The two housing parts can be advantageously realized from different materials.

The two housing parts can be advantageously produced in accordance with different production methods.

Each of the housing parts can form a section of the inner contour of the spiral channel. Complex shapes can be realized for the spiral channel by the assembly of the housing parts and the contour ring. As a result, it is possible to dispense with undercuts, which would have been required to realize such a complex spiral channel with only housing part.

In the case of another advantageous embodiment, the contour ring can be disposed in one of the housing parts and another of the housing parts can delimit the compressor impeller receiving chamber at least in part.

In this way, the at least one housing part with the contour ring can be optimized for mounting thereof and if applicable for realizing a section of the inner contour of the spiral channel. The other housing part can be optimized for delimiting the compressor impeller receiving chamber. In addition, the other housing part can also form a section of the inner contour of the spiral channel at least in part.

The compressor housing can comprise an upper part (already mentioned above) and a middle part. The contour ring can be disposed advantageously in the upper part. The middle part can advantageously radially outwardly surround and delimit the compressor impeller receiving chamber with respect to the rotational axis.

To assemble the compressor housing, the contour ring and the middle part can advantageously be inserted into the upper part. The middle part can be advantageously connected to the upper part, in particular welded, glued and/or pressed in. The upper part with the contour ring and the middle part can be mounted as the case may be on the bearing seat.

With another advantageous embodiment, the contour ring can comprise plastic, in particular elastomer, and/or metal or be made of such a material.

The contour ring can be realized in a simple manner of plastic. Plastic can be molded in a simple manner.

The contour ring can be realized of plastic having a low weight.

The contour ring can be advantageously injected, cast, sintered or mechanically produced in particular of plastic.

With another advantageous embodiment, the contour ring can comprise a fibrous and/or mat-like material or be made of such a material.

The mechanical resistance, in particular the ductility, of the contour ring can be improved with a fibrous and/or mat-like material. In particular, the breaking resistance thereof can be increased.

The fibrous and/or mat-like material can be impregnated advantageously with resins. The mechanical resistance, in particular the ductility, can be improved further in this way.

In the case of another advantageous embodiment, the contour ring can be designed as a burst-protection ring.

As a result, it can be suitable as a containment aid. The contour ring can consist advantageously of an elastomer-like material. Thus, the fracture resistance thereof can be improved further.

If the compressor impeller bursts, the contour ring can prevent the impeller parts of the compressor impeller from punching though the compressor housing. The contour ring can at least dissipate or compensate for enough of the kinetic energy of the impeller parts that the burst impeller parts can be intercepted or diverted.

In the case of another advantageous embodiment, the at least one housing part can consist of plastic at least in part.

Plastic parts can be realized simply. They can be formed simply, in particular injected or cast. Complex shapes can also be realized of plastic. The at least one housing part can be provided of plastic having a low weight.

All housing parts of the compressor housing can advantageously be made of plastic or comprise plastic.

The compressor housing of a radial compressor can be disposed in an exhaust gas turbocharger of an internal combustion engine or in an electrically driven compressor (E-booster) of an internal combustion engine. The compressor housing can likewise be a housing of a compressor driven in another manner.

### BRIEF DESCRIPTION OF THE DRAWINGS

Additional advantages, features and details of the invention will be made clear in the following description in which an exemplary embodiment of the invention will be explained in more detail based on the drawing. A person skilled in the art will also expediently consider individually the features disclosed in combination in the drawing, the description and the claims and combine them into further meaningful combinations.

The single FIGURE schematically shows an axial section of one half of a compressor housing of a radial compressor, wherein a contour ring is disposed in an upper part of the compressor housing, with which contour ring a section of the inner contour of a spiral channel is realized.

The same components are provided with the same reference numbers in the FIGURE.

### DETAILED DESCRIPTION OF THE INVENTION

The FIGURE shows a cross section of one half of a housing 16 for a radial compressor of an exhaust gas turbocharge of an internal combustion engine, which housing is formed of two housing parts, specifically an upper part 10 and a middle part 12, and a contour ring 14. The exhaust gases of the internal combustion engine drive a turbine wheel, which is connected to a compressor impeller (not shown in the FIGURE) for rotation therewith. The compressor impeller is rotatably mounted in the housing 16 around a rotational axis 18 indicated in the drawing. Through the rotation of the compressor impeller, combustion air is suctioned in an intake tract of the internal combustion engine and compressed to an increased charging pressure, under which the combustion air is conveyed to cylinders of the internal combustion engine.

Unless otherwise stated, the rotational axis 18 forms the reference for the indications of “axial”, “radial”, “coaxial”, “circumferential” and “in the circumferential direction”.

The upper part 10, the middle part 12 and the contour ring 14 respectively surround the rotational axis 18 circumferentially. The upper part 10, the middle part 12 and the contour ring 14 consist of a thermoplastic plastic.

The middle part 12 is disposed within the upper part 10. A first connecting zone 20 and a second connecting zone 22 are formed on the upper part 10.

A corresponding radially outer circumferential size of a coaxial cylindrical section 24 of the middle part 12 abuts the connecting zone 20.

The second connecting zone 22 extends circumferentially and radially. A front surface 26 of a rounded section 32 of the middle part 12 abuts the second connecting zone 22. The cylindrical section 24 merges in one piece into the rounded section 32 of the middle part 12.

The first connecting zone 20 and the cylindrical section 24 along with the second connecting zone 22 and the front surface 26 respectively form welding zones.

Formed on the upper part 10 is an upper curve section 28 that is downwardly open in the FIGURE, and which extends circumferentially in an annular manner. On the lower (in the FIGURE) side thereof facing in the axial direction [of] the middle part 12, the upper end section edge section 28 forms a circumferential trough that is downwardly open. The radial connecting surface 22 is situated at the radially inner end of the upper curve section 28. An inner contour of the rounded section 32 of the middle part 12 merges into an inner contour of the upper curve section 28 [of the] upper part 10. The rounded section 32 on the middle part 12 makes a corresponding radially inner undercut on the upper part 10 superfluous.

On the radially outer circumferential side, the upper curve section 28 merges into an axially extending cylindrical sleeve section 34. The sleeve section 34 projects in the axial direction over an underside of the rounded section 32 of the middle part 12 that is axially opposite from the front face 26.

The sleeve section 34 has a step 36 on a radially inner circumferential side. The step 36 is situated axially approximately at the height of the radial connecting surface 22. Viewed from the upper curve section 28 in the axial direction, an axial contour ring receptacle 38 that is offset radially outwardly is situated behind the step 36. The axial contour ring receptacle 38 merges on its side facing away from the step 36 in the axial direction into a bearing ring receptacle 40. The axial contour ring receptacle 38 and the bearing ring receptacle 40 extend radially outwardly along an imaginary coaxial cylinder jacket.

A radially outer circumferential side of a coaxial cylindrical retaining section 42 of the contour ring 14 abuts a radially inner circumferential side of the axial contour ring receptacle 38. The edge of the retaining section 42 abuts the step 36 of the contour ring receptacle 38. The sleeve section 34 projects axially over the retaining section 42. The bearing ring receptacle 40 is situated axially behind the retaining section 42.

The contour ring 14 comprises radially inwardly an annular lower outer curve section 44. The lower outer curve section 44 is connected in one piece on its radially outer edge to the edge of the retaining section 42 facing the step 36 of the axial contour ring receptacle 38. A radially inner edge of the lower outer curve section 44 is situated, viewed axially, approximately at the height of the lower edge of the retaining section 42 facing away from the step 36 of the axial contour ring receptacle 38. The lower outer curve section 44 makes a corresponding radially outer undercut on the upper part 10 superfluous.

A spiral channel 46 is formed by the upper curve section 28 on the upper part 10, the rounded section 32 on the middle part 12 and the lower outer curve section 44 on the contour ring 14. As is known, combustion air of the internal combustion engine compressed with the radial compressor flows in the spiral channel 46. The to-be-permeated cross-sectional surface thereof increases or decreases circumferentially, depending upon the viewing direction. An annular gap 48 between the lower outer curve section 44 and the rounded section 32 forms an inlet for the combustion air in the spiral channel 46. Furthermore, the spiral channel 46 comprises an outlet (not shown in the FIGURE) for the combustion air.

Furthermore, a circumferential annular space 50 is situated between the upper part 10 and the middle part 12. The annular space 50 radially outwardly surrounds the cylindrical section 24.

The contour ring 14 is fixed in its position in the contour ring receptacle 38 of the upper part 10 by means of a force-fit plug-in connection.

The upper part 10 is positioned on a front side of a bearing seat 52. In doing so, the bearing seat receptacle 40 surrounds an end section on the radial outer circumferential side of the bearing seat 52. A front side of the bearing seat 52 facing the middle part 12 is spaced apart from an underside of the middle part 12 so that a gap 54 is formed. The gap 54 connects a compressor impeller receiving chamber 56 inside the cylindrical section 24 to the annular gap 48 of the spiral channel 46. Furthermore, the bearing seat 52 comprises a bearing (not shown in the FIGURE) for the compressor impeller. The compressor impeller is disposed in the compressor impeller receiving chamber 56, but also projects into the gap 54. The bearing is coaxial to the rotational axis. The combustion air can be conveyed from the compressor impeller receiving chamber 56 to the spiral channel 46 via the gap 54 and the annular gap 48.

On a front side thereof, the bearing seat 52 radially outwardly comprises a radial contour ring receptacle 58 that runs circumferentially and radially. Resting in the radial contour ring receptacle 58 are the lower edges of the lower outer curve section 44 and of the retaining section 42 of the contour ring 14 that face away from the step 36 of the axial contour ring receptacle 38. Thus, the contour ring 14 is positioned and held between the upper part 10 and the bearing seat 52.

The upper part 10, the middle part 12 and the contour ring 14 are fabricated separately of plastic to produce the housing 16.

The contour ring 14 is inserted with a force-fit in the axial direction into the axial contour ring receptacle 38 of the upper part 10. The middle part 12 is inserted in the axial direction into the upper part 10 so that the connecting zones 20 and 22 of the upper part 10 and the cylinder section 24 and the front face 26 of the middle part 12 fit closely together. Then the upper part 10 and the middle part 12 are welded to each other.

Subsequently, the compressor impeller is inserted into the compressor impeller receiving chamber 56 and the bearing seat 52 is placed on the upper part 10 so that the contour ring 14 is fixed between the bearing seat 52 and the upper part 10.

I claim:

1. A compressor housing of a radial compressor of a turbocharger for an internal combustion engine, comprising:
at least one housing part, the housing parts mated together to form the compressor housing, the compressor housing defining therein
a compressor impeller receiving chamber;
a spiral channel arranged radially outwardly of the compressor impeller receiving chamber and surrounding the compressor impeller receiving chamber with respect to a rotational axis of a compressor impeller;
a contour ring arranged within the at least one housing part, the contour ring at least radially outwardly surrounding the spiral channel and forming at least one section of a radially outward inner contour of the spiral channel.

2. The compressor housing according to claim 1, wherein the at least one housing part forms a portion of the inner contour of the spiral channel.

3. The compressor housing according to claim 1, wherein the at least one housing part is disposed on a bearing seat of the radial compressor.

4. The compressor housing according to claim 3, wherein the contour ring is disposed between the at least one housing part and the bearing seat.

5. The compressor housing according to claim 3, wherein the compressor housing comprises at least two housing parts.

6. The compressor housing according to claim 1, wherein the contour ring is disposed in one of the housing parts and another of the housing parts delimits the compressor impeller receiving chamber at least in part.

7. The compressor housing according to claim 1, wherein the contour ring comprises at least one of: plastic, an elastomer, or metal.

8. The compressor housing according to claim 1, wherein the contour ring (14) comprises a fibrous and/or mat-like material.

9. The compressor housing according to claim 1, wherein the contour ring is designed as a burst-protection ring.

10. The compressor housing according to claim 1, wherein the at least one housing part is made of plastic.
